(19) United States
(12) Patent Application Publication
(10) Pub. No.: US 2023/0318046 A1
(43) Pub. Date: Oct. 5, 2023

(54) Bipolar Storage Battery

(71) Applicants: Furukawa Electric Co., Ltd., Tokyo (JP); The Furukawa Battery Co., Ltd., Yokohama (JP)

(72) Inventors: Hiroki Tanaka, Tokyo (JP); Yasuo Nakajima, Tokyo (JP); Kenichi Suyama, Tokyo (JP); Akira Tanaka, Tokyo (JP); Miho Yamauchi, Tokyo (JP)

(21) Appl. No.: 18/331,452

(22) Filed: Jun. 8, 2023

Related U.S. Application Data
(63) Continuation of application No. PCT/JP2021/040255, filed on Nov. 1, 2021.

(30) Foreign Application Priority Data
Dec. 10, 2020 (JP) 2020-204825

(51) Int. Cl. H01M 10/18; H01M 4/68

(52) U.S. Cl. CPC H01M 10/18; H01M 4/685; H01M 2004/029

(57) ABSTRACT

A bipolar storage battery includes a bipolar electrode including a positive electrode, a negative electrode, and a substrate provided with the positive electrode on one surface and the negative electrode on another surface. The bipolar storage battery includes a first adhesive provided between the one surface of the substrate and the positive electrode to bond the positive electrode to the substrate. The first adhesive is a conductive adhesive. This configuration can provide a bipolar storage battery in which battery performance is less likely to deteriorate by preventing an electrolytic solution from easily infiltrating an interface between a positive electrode and an adhesive layer even when growth occurs in the positive electrode due to corrosion by sulfuric acid contained in the electrolytic solution.

### CROSS-REFERENCE TO RELATED APPLICATION(S)

This application is a continuation of PCT Application No. PCT/JP2021/040255, filed Nov. 1, 2021, the disclosure of which is incorporated herein in its entirety by reference.

### TECHNICAL FIELD

Embodiments of the present invention relate to a bipolar storage battery.

### BACKGROUND

In recent years, power generation facilities using natural energy such as sunlight and wind power have increased. In such power generation facilities, because the power generation amount cannot be controlled, the power load is leveled by using a storage battery. That is, when the power generation amount is larger than the consumption amount, the difference is charged into the storage battery, and when the power generation amount is smaller than the consumption amount, the difference is discharged from the storage battery. As the above-described storage battery, a lead-acid storage battery is frequently used for economic efficiency, safety, and the like. As such a conventional lead-acid storage battery, for example, one described in JP Patent Publication No. 6124894 B2 below is known.

In the lead-acid storage battery described in JP Patent Publication No. 6124894 B2, a substrate (bipolar plate) made of resin is attached inside a frame (rim) made of resin having a picture frame shape. A positive lead layer and a negative lead layer are disposed on one surface and another surface of the substrate. A positive active material layer is adjacent to the positive lead layer. A negative active material layer is adjacent to the negative lead layer. In addition, a glass mat (electrolytic layer) containing an electrolytic solution is disposed inside a spacer made of resin having a picture frame shape. Then, a plurality of frames and spacers is alternately stacked and assembled.

Further, the positive lead layer and the negative lead layer are directly joined in a plurality of perforations formed in the substrate. That is, the lead-acid storage battery described in JP Patent Publication No. 6124894 B2 is a bipolar lead-acid storage battery in which a plurality of substrates having perforations (communication holes) for communicating one surface side and another surface side and cell members is alternately stacked. The cell member includes a positive electrode in which the positive active material layer is provided on the positive lead layer, a negative electrode in which the negative active material layer is provided on the negative lead layer, and the electrolytic layer interposed between the positive electrode and the negative electrode. The positive lead layer of one cell member and the negative lead layer of another cell member enter the inside of the perforations of the substrate and are joined, and the cell members are connected in series.

### SUMMARY

In the lead-acid storage battery described in aforementioned JP Patent Publication No. 6124894 B2, the substrate and the lead layer are laminated by a method such as plating. However, in the adhesion by a method such as plating, for example, only an anchor effect can be expected in the adhesion between the substrate and the lead layer, and the reliability of the manufactured lead-acid storage battery is low. Therefore, for example, a method is conceivable in which an adhesive is interposed between the substrate and the lead layer to bond them.

Such a state is illustrated in FIGS. 7A, 7B, and 7C. The lead layers bonded to the substrate using an adhesive include the positive lead layer and the negative lead layer, and the positive lead layer is described as an example. That is, as illustrated in FIG. 7A, the positive electrode of a bipolar electrode is configured such that a positive lead layer 220 is disposed on one surface of a substrate 210 made of resin with an adhesive layer 240 interposed therebetween, and a positive active material layer (not illustrated) is disposed on the positive lead layer 220.

In the bipolar lead-acid storage battery as described above, the positive lead layer 220 can be corroded by sulfuric acid contained in the electrolytic solution to generate a coating film 260 of a corrosion product (lead oxide) on the front surface of the positive lead layer 220 (see FIG. 7B). Then, there has been a possibility that the development of the coating film 260 of the corrosion product causes elongation (growth) in the positive lead layer 220.

In addition, there has been a possibility that the positive lead layer 220 and the adhesive layer 240 are separated due to this growth. The electrolytic solution infiltrates the interface between the positive lead layer 220 and the adhesive layer 240, and the corrosion of the positive lead layer 220 due to sulfuric acid further proceeds (see FIG. 7C). As a result, when corrosion reaches, for example, the back surface of the positive lead layer 220 (the surface facing the substrate 210), there has been a case where a short circuit or the like occurs, and the performance of the battery deteriorates.

In addition, to directly join the positive lead layer and the negative lead layer inside the perforations, for example, resistance welding is used. However, a conduction hole that makes the positive lead layer and the negative lead layer conductive may be contaminated by an adhesive, and an adhesive that bonds the substrate and the positive lead layer or the negative lead layer during welding may be interposed on a joint surface between the positive lead layer and the negative lead layer. Because the adhesive has a very high resistance, when welding is performed in this state, for example, there is a possibility that sparks may occur and joining failure may occur.

When the electrolytic solution enters between the substrate and the positive lead layer due to the joining failure, there is a possibility that the electrolytic solution enters between the substrate and the negative lead layer via, for example, perforations to cause liquid junction, which causes a reduction in voltage and deterioration of the performance.

An object of the present invention is to provide a bipolar storage battery in which battery performance is less likely to deteriorate by preventing an electrolytic solution from easily infiltrating an interface between a positive electrode and an adhesive layer even when growth occurs in the positive electrode due to corrosion by sulfuric acid contained in the electrolytic solution. Another object of the present invention is reducing joining failure during manufacturing and greatly suppressing occurrence of liquid junction, by achieving both reliable bonding of a substrate to the positive electrode and a negative electrode and ensuring conduction in a conductive portion, during welding of the conductive portion to the positive electrode and the negative electrode.

A bipolar storage battery according to an embodiment of the present invention is a bipolar storage battery including a bipolar electrode. The bipolar electrode includes a positive electrode, a negative electrode, and a bipolar plate provided with the positive electrode on one surface and the negative electrode on an other surface. The bipolar storage battery includes a first adhesive provided between the one surface of the bipolar plate and the positive electrode to bond the positive electrode to the bipolar plate. The first adhesive is a conductive adhesive.

According to the present invention, a bipolar storage battery includes a bipolar electrode including a positive electrode, a negative electrode, and a bipolar plate provided with the positive electrode on one surface and the negative electrode on an other surface. The bipolar storage battery includes a first adhesive provided between the one surface of the bipolar plate and the positive electrode to bond the positive electrode to the bipolar plate. The first adhesive is a conductive adhesive. By adopting such a configuration, the resistance of the adhesive itself is suppressed to be low, and even when current is applied to the positive lead layer and the negative lead layer at the time of welding, it is possible to suppress the occurrence of sparks and joining failure. Therefore, the battery performance is less likely to deteriorate by preventing an electrolytic solution from easily infiltrating an interface between a positive electrode and an adhesive layer even when growth occurs in the positive electrode due to corrosion by sulfuric acid contained in the electrolytic solution. Additionally, adopting this configuration can reduce joining failure during manufacturing and greatly suppress occurrence of liquid junction, by achieving both reliable bonding of a bipolar plate to the positive electrode and a negative electrode and ensuring conduction in a conductive portion, during welding of the conductive portion to the positive electrode and the negative electrode.

### BRIEF DESCRIPTION OF THE DRAWINGS

FIG. 1 is a cross-sectional view illustrating a structure of a bipolar lead-acid storage battery according to an embodiment of the present invention.

FIG. 2 is an enlarged cross-sectional view of a bipolar electrode illustrating a structure of a main part of a bipolar lead-acid storage battery related to a welding step in a first embodiment.

FIG. 3 is an enlarged cross-sectional view of the bipolar electrode illustrating a structure of a main part of the bipolar lead-acid storage battery in a state where welding is completed in the first embodiment.

FIG. 4 is an enlarged cross-sectional view of a bipolar electrode illustrating a structure of a main part of a bipolar lead-acid storage battery related to a welding step in a second embodiment.

FIG. 5 is an enlarged cross-sectional view of the bipolar electrode illustrating a structure of a main part of the bipolar lead-acid storage battery in a state where welding is completed in the second embodiment.

FIG. 6 is a partially enlarged plan view illustrating a state of a communication hole provided in a substrate (bipolar plate) and an adhesive provided on the substrate in the second embodiment.

FIGS. 7A, 7B, and 7C are views illustrating a state in which an electrolytic solution infiltrates an interface between a positive lead layer and an adhesive layer as a result of growth occurring in the positive lead layer due to corrosion by sulfuric acid contained in the electrolytic solution in a conventional bipolar lead-acid storage battery.

### DETAILED DESCRIPTION

Hereinafter, embodiments of the present invention will be described in detail with reference to the drawings. Note that the embodiments described below illustrate an example of the present invention. In addition, various changes or improvements can be added to the present embodiments, and a mode to which such changes or improvements are added can also be included in the present invention. These embodiments and modifications thereof are included in the scope and gist of the invention and are included in the scope of the invention described in the claims and its equivalents. Note that, hereinafter, a lead-acid storage battery will be described as an example from among various storage batteries.

### First Embodiment

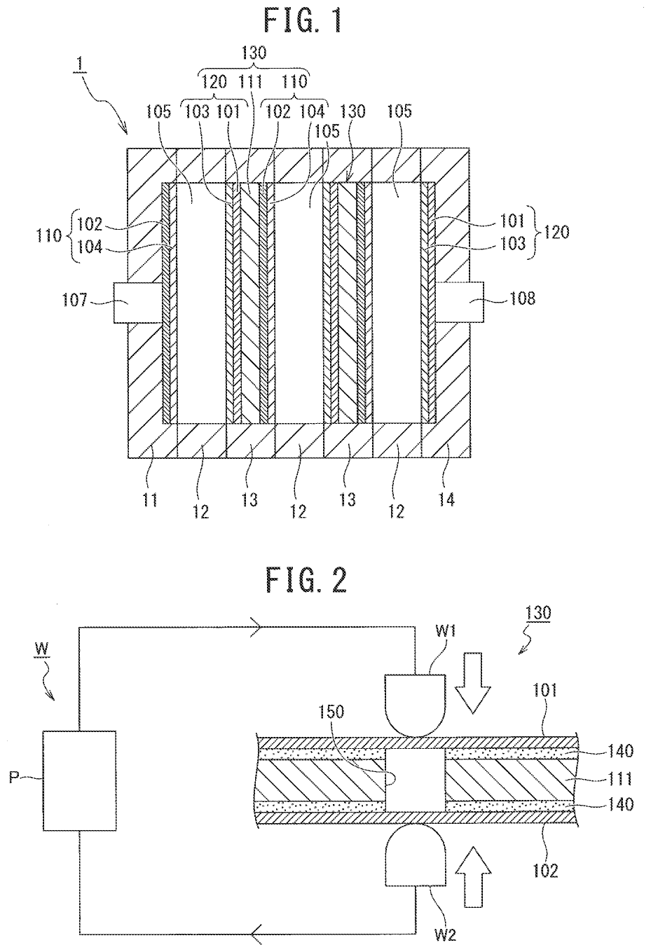

A structure of a bipolar lead-acid storage battery 1 according to embodiments of the present invention will be described with reference to FIG. 1. FIG. 1 is a cross-sectional view describing a structure of the bipolar lead-acid storage battery 1 according to embodiments of the present invention.

The bipolar lead-acid storage battery 1 illustrated in FIG. 1 includes a first plate unit in which a negative electrode 110 is fixed to a first plate 11 (also called an endplate) having a flat plate shape, a second plate unit in which an electrolytic layer 105 is fixed to the inside of a second plate 12 (also called a spacer) having a frame plate shape, a third plate unit in which a bipolar electrode 130 having a positive electrode 120 formed on one surface of a substrate 111 (also called a bipolar plate) and a negative electrode 110 formed on another surface is fixed to the inside of a third plate 13 (also called a rim) having a frame plate shape, and a fourth plate unit in which the positive electrode 120 is fixed to a fourth plate 14 (also called an endplate) having a flat plate shape.

The second plate unit and the third plate unit are alternately stacked between the first plate unit and the fourth plate unit to form the bipolar lead-acid storage battery 1 having, for example, a substantially rectangular parallelepiped shape. The number of each of the second plate units and the third plate units to be stacked is set such that the storage capacity of the bipolar lead-acid storage battery 1 has a desired numerical value.

A negative terminal 107 is fixed to the first plate 11, and the negative electrode 110 and the negative terminal 107 fixed to the first plate 11 are electrically connected. A positive terminal 108 is fixed to the fourth plate 14, and the positive electrode 120 and the positive terminal 108 fixed to the fourth plate 14 are electrically connected.

The first plate 11, the second plate 12, the third plate 13, and the fourth plate 14 are formed of, for example, a well-known molded resin. Then, the first plate 11, the second plate 12, the third plate 13, and the fourth plate 14 are fixed to each other by an appropriate method so that the inside is in a sealed state and the electrolytic solution does not flow out.

The electrolytic layer 105 is made of, for example, a glass fiber mat impregnated with an electrolytic solution containing sulfuric acid.

The substrate 111 is made of, for example, thermoplastic resin. Examples of the thermoplastic resin forming the substrate 111 include acrylonitrile-butadiene-styrene copolymer (ABS) resin or polypropylene. These thermoplastic resins are excellent in moldability and in sulfuric acid resistance. Hence, even when the electrolytic solution contacts the substrate 111, decomposition, deterioration, corrosion, and the like hardly occur in the substrate 111.

The substrate 111 is provided with a communication hole 150 that allows the one surface and the other surface to communicate with each other (see FIG. 2 to be described below). A positive lead layer 101 and a negative lead layer 102 are joined inside the communication hole 150, so that they are electrically connected to each other, and a conductive portion between the positive electrode and the negative electrode is formed.

The positive electrode 120 includes the positive lead layer 101, which is a positive current collector made of lead or a lead alloy and arranged on the one surface of the substrate 111, and a positive active material layer 103 arranged on the positive lead layer 101. This positive lead layer 101 is bonded to the one surface of the substrate 111 by an adhesive provided between the one surface of the substrate 111 and the positive lead layer 101. Accordingly, the adhesive, the positive lead layer 101, and the positive active material layer 103 are stacked in this order on the one surface (in the drawings such as FIG. 2 to be described below, a surface facing upward on the plane of paper) of the substrate 111.

The negative electrode 110 includes the negative lead layer 102, which is a negative current collector made of lead or a lead alloy and arranged on the other surface of the substrate 111 (in the drawings such as FIG. 2, a surface facing downward on the plane of paper), and a negative active material layer 104 arranged on the negative lead layer 102. This negative lead layer 102 is bonded to the other surface of the substrate 111 by an adhesive provided between the other surface of the substrate 111 and the negative lead layer 102. The positive electrode 120 and negative electrode 110 are electrically connected through the communication hole 150 described above.

Note that, in the cross-sectional view of the bipolar electrode 130 as illustrated, for example, in FIG. 2 described below, among the elements constituting the positive electrode 120, only the positive lead layer 101 is illustrated, and the positive active material layer 103 is omitted. In addition, similarly, among the elements constituting the negative electrode 110, only the negative lead layer 102 is illustrated, and the negative active material layer 104 is omitted.

In the bipolar lead-acid storage battery 1 of the first embodiment having such a configuration, as described above, the substrate 111, the positive lead layer 101, the positive active material layer 103, the negative lead layer 102, and the negative active material layer 104 constitute the bipolar electrode 130. The bipolar electrode is an electrode having both positive and negative electrode functions in one electrode. The bipolar lead-acid storage battery 1 of the embodiment of the present invention has a battery configuration in which a plurality of cell members formed by interposing the electrolytic layer 105 between the positive electrode 120 and the negative electrode 110 is alternately stacked and assembled to connect the cell members in series.

Next, a step of bonding the positive lead layer 101 and the negative lead layer 102 in the communication hole 150 provided in the substrate 111 will be described below. FIG. 2 is an enlarged cross-sectional view of the bipolar electrode 130 illustrating a structure of a main part of the bipolar lead-acid storage battery 1 related to a welding step in the first embodiment. Further, FIG. 2 illustrates a part of a welding machine for the welding step.

As illustrated in FIG. 2, in the bipolar electrode 130, a first adhesive 140 is provided on the one surface of the substrate 111, and the positive lead layer 101 is arranged thereon, and both are bonded. In addition, a first adhesive 140 is provided on the other surface of the substrate 111, and the negative lead layer 102 is arranged thereon, and both are bonded. Note that, as described above, illustration of the positive active material layer 103 and the negative active material layer 104 is omitted.

Here, as the first adhesive 140 for bonding the substrate 111, the positive lead layer 101, and the negative lead layer 102, a conductive adhesive is used. Examples of a resin used for the conductive adhesive include thermosetting resins such as epoxy, polyimide, phenol, and bismaleimide, and thermoplastic resins such as polyester, polyurethane, and acrylic, or any combination thereof. Among them, in consideration of heat resistance, moisture resistance, electrical characteristics, bonding force, curability, and the like, epoxy resin having a balance therebetween is more suitably used.

Then, as a conductive filler contained in the resin, for example, silver, gold, copper, nickel, silver-palladium, graphite, silver-coated copper powder, or the like can be suitably used.

As the conductive adhesive, in consideration of joining of the positive lead layer 101 and the negative lead layer 102 in the communication hole 150, it is preferable to mix a plurality of conductive fillers having different shapes such as a flake shape, a spherical shape, or the like or having different particle sizes in the resin to improve low resistance and high thermal conductivity. For example, in the case of mixing silver as a conductive filler, addition of 80 to 90 percentage by weight (wt %) to the resin improves conductivity, and in particular, addition of 85 wt % is suitable.

In the first embodiment, the first adhesive 140 is provided on the entire surfaces of the one surface and the other surface of the substrate 111 to cover both surfaces. However, as described above, the first adhesive 140 is applied to the one surface and the other surface of the substrate 111 and is not provided inside the communication hole 150.

As described above, the positive lead layer 101 is bonded to the one surface of the substrate 111 via the first adhesive 140 provided on the one surface of the substrate 111. In addition, the negative lead layer 102 is bonded to the other surface of the substrate 111 via the first adhesive 140 provided on the other surface of the substrate 111.

At this stage, the positive lead layer 101 and the negative lead layer 102 bonded to the substrate 111 do not enter the inside of the communication hole 150 but are arranged to cover the opening of the communication hole 150. Then, in this state, the positive lead layer 101 and the negative lead layer 102 are joined in the communication hole 150.

A welding machine W is used for joining the positive lead layer 101 and the negative lead layer 102. In the embodiment of the present invention, resistance welding is performed using the welding machine W illustrated in FIG. 2. The welding machine W includes a power supply P and two electrodes W1 and W2 connected to the power supply P. Current applied from the power supply P to the electrode W1 and the electrode W2 flows from the power supply P to the electrode W1 and from the electrode W2 to the power supply P.

At the time of welding, the electrode W1 is in contact with the positive lead layer 101, and the electrode W2 is in contact with the negative lead layer 102. Then, the electrodes move toward the inside of the communication hole 150 in directions indicated by the arrows in FIG. 2 while applying pressure to approach each other. As described above, because the electrodes W1 and W2 are in contact with the positive lead layer 101 and negative lead layer 102, the positive lead layer 101 and the negative lead layer 102 are also deformed to be curved because of the movement of the electrodes W1 and W2 and come into contact with each other in the communication hole 150. At this time, the current flows in the direction of the arrows along the connections of the welding machine W, and the lead layers 101, 102 are fused and joined to each other.

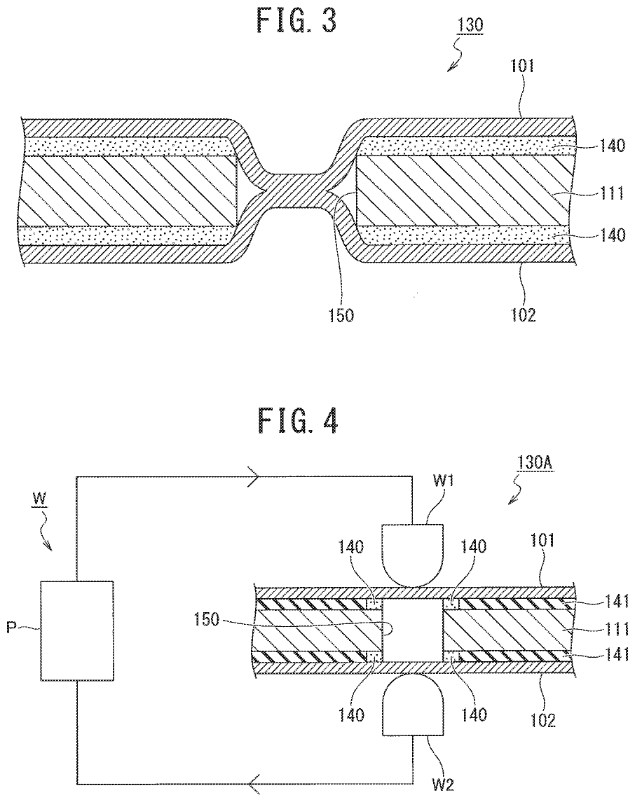

Such a state is illustrated in FIG. 3. FIG. 3 is an enlarged cross-sectional view of the bipolar electrode 130 illustrating a structure of a main part of the bipolar lead-acid storage battery 1 in a state where welding is completed in the first embodiment. Note that, in FIG. 3, the drawing of the welding machine W is omitted.

Portions of the positive lead layer 101 and the negative lead layer 102 that are pressed in contact with the electrode W1 and the electrode W2 approach and contact each other in the communication hole 150. Then, when the current is applied by the welding machine W, they are joined to each other in the communication hole 150.

When the positive lead layer 101 and the negative lead layer 102 are joined, and welding is performed before complete curing, the first adhesive 140 provided with respect to the substrate 111 has a reduced viscosity due to heat from the welding. Therefore, there is a possibility that the first adhesive 140 enters the communication hole 150 during welding and contaminates the communication hole 150. Additionally, it is also conceivable that the first adhesive 140 enters a joint part between the positive lead layer 101 and the negative lead layer 102.

However, as described above, because the first adhesive 140 used in the first embodiment is a conductive adhesive, the resistance of the adhesive itself is suppressed to be low. Even when current is applied to the positive lead layer 101 and the negative lead layer 102 at the time of welding, it is possible to suppress the occurrence of sparks and joining failure.

That is, the substrate 111, the positive lead layer 101, and the negative lead layer 102 are not laminated by a method such as plating but are firmly bonded by the first adhesive 140 provided to cover the entire surfaces of the substrate 111, so that the possibility of occurrence of growth can be reduced.

Moreover, because the first adhesive 140 is a conductive adhesive, the occurrence of sparks can be greatly suppressed, and joining failure between the positive lead layer 101 and the negative lead layer 102 can be reduced. Therefore, it is possible to prevent the electrolytic solution from entering between the substrate 111 and the negative lead layer 102 via the communication hole 150 due to joining failure. The electrolytic solution entering between the substrate 111 and the negative lead layer 102 via the communication hole 150 could cause liquid junction, a reduction in voltage, and/or deterioration of the performance of the bipolar lead-acid storage battery 1.

### Second Embodiment

Next, the second embodiment of the present invention will be described. Note that, in the second embodiment, the same constituent elements as those described in the above-described first embodiment are denoted by the same reference numerals, and redundant description of the same constituent elements will be omitted.

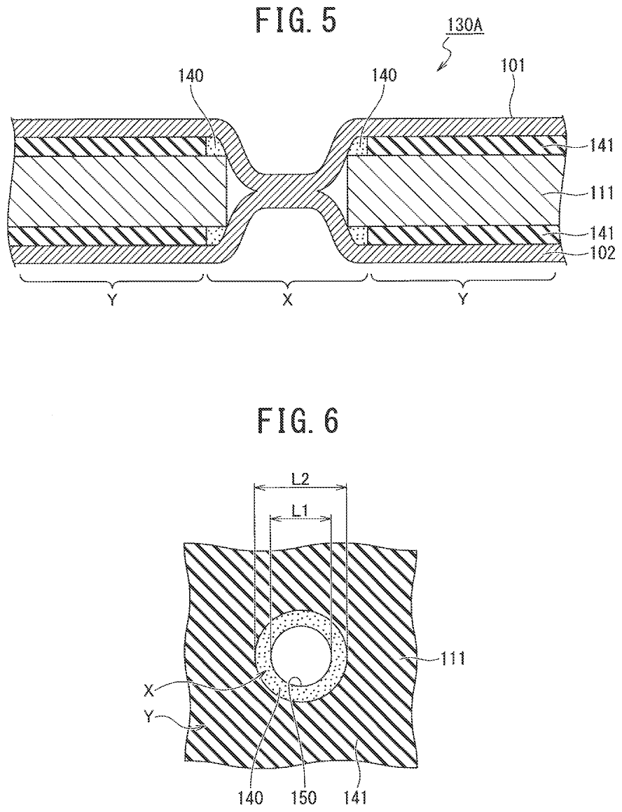

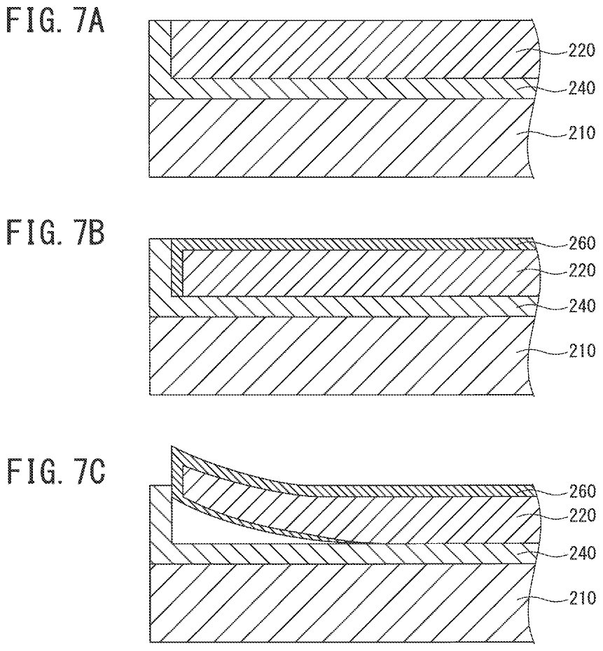

FIG. 4 is an enlarged cross-sectional view of a bipolar electrode 130A illustrating a structure of a main part of a bipolar lead-acid storage battery 1 related to a welding step in the second embodiment. In addition, FIG. 5 is an enlarged cross-sectional view of the bipolar electrode 130A illustrating a structure of a main part of the bipolar lead-acid storage battery 1 in a state where welding is completed in the second embodiment. The use of the welding machine W and performing the resistance welding in the welding step in the second embodiment are similar as in the case of the first embodiment.

The second embodiment is different from the first embodiment in that a region where a first adhesive 140, which is a conductive adhesive, is provided is different. The first adhesive 140 is provided in a peripheral region X of a communication hole 150, and a second adhesive 141 is provided in another region Y other than the peripheral region X.

That is, as illustrated in FIG. 5, the first adhesive 140 is provided only in the peripheral region X of the communication hole 150, and the second adhesive 141 is provided in the other region Y of the substrate 111. This second adhesive 141 is not a conductive adhesive, unlike the first adhesive 140. Instead, for example, the second adhesive 141 is an adhesive that does not contain a conductive filler and is generally used for bonding a substrate and a lead layer. Note that a method of disposing the first adhesive 140 and the second adhesive 141 can also be freely selected, such as coating or the like.

Further, FIG. 6 is a partially enlarged plan view illustrating a state of the communication hole 150 provided in the substrate 111 and an adhesive provided on the substrate 111 in the second embodiment. As illustrated in FIG. 6, the substrate 111 is provided with the communication hole 150, the first adhesive 140 is provided in the peripheral region X of the communication hole 150, and the second adhesive 141 is provided in the other region Y other than the peripheral region X of the substrate 111.

Here, the peripheral region X in which the first adhesive 140 is provided has the same shape as the shape of the communication hole 150 and is a region surrounding the communication hole 150 about the center of the communication hole 150. The communication hole 150 illustrated in FIG. 6 has a circular shape. Therefore, the first adhesive 140 is provided so that the peripheral region X also has a circular shape. Moreover, the center of the shape of the peripheral region X coincides with the center of the communication hole 150. Therefore, as illustrated in FIG. 6, when the communication hole 150 has a circular shape, the peripheral region X concentrically extends around the communication hole 150.

In addition, when the communication hole 150 has a circular shape, the peripheral region X in which the first adhesive 140 is provided is a region between 1.1 times and 1.5 times, inclusive, the diameter of the communication hole 150. That is, as illustrated in FIG. 6, when the diameter of the communication hole 150 is represented by L1, a diameter L2 of the peripheral region X is between 1.1 times L1 and 1.5 times L1, inclusive.

Note that, here, the case where the communication hole 150 has a circular shape has been described as an example, but the shape of the communication hole 150 is not limited to a circular shape and may be any shape such as a quadrangular shape or a triangular shape. The shape and range of the peripheral region X in which the first adhesive 140 is provided are set according to the shape of the communication hole 150.

In addition, it has been described as an example that nothing is arranged inside the communication hole 150, and the positive lead layer 101 and the negative lead layer 102 are directly joined in the communication hole 150. However, instead of such a joining method, for example, a conductor may be inserted into the communication hole 150. The positive lead layer 101 and the negative lead layer 102 may be joined to the conductor to form a conductive portion to conduct the positive lead layer 101 and the negative lead layer 102 to be electrically connected between the positive electrode and the negative electrode.

Note that, as described above, in the embodiments of the present invention, a bipolar type lead-acid storage battery has been described as an example. However, when the aforementioned descriptive content applies to other storage batteries in which other metals (for example, aluminum, copper, or nickel), alloys, or conductive resins are used instead of lead for a current collector, such application is naturally not excluded.

The following is a list of reference signs used in this specification and in the drawings.
1 Bipolar lead-acid storage battery
101 Positive lead layer
102 Negative lead layer
103 Positive active material layer
104 Negative active material layer
105 Electrolytic layer
110 Negative electrode
111 Substrate (bipolar plate)
120 Positive electrode
130 Bipolar electrode
130A Bipolar electrode
140 First adhesive
141 Second adhesive
150 Communication hole
X Peripheral region
Y Other region

What is claimed is:

1. A bipolar storage battery comprising:
a bipolar electrode including a positive electrode, a negative electrode, and a bipolar plate provided with the positive electrode on one surface and the negative electrode on an other surface, wherein:
a first adhesive is provided between the one surface of the bipolar plate and the positive electrode to bond the positive electrode to the bipolar plate, and
the first adhesive is a conductive adhesive.

2. The bipolar storage battery according to claim 1, wherein the positive electrode includes a positive current collector, the negative electrode includes a negative current collector, and the positive current collector and the negative current collector are made of lead or a lead alloy.

3. The bipolar storage battery according to claim 1, wherein the first adhesive is provided to cover the one surface of the bipolar plate.

4. The bipolar storage battery according to claim 3, wherein the positive electrode includes a positive current collector, the negative electrode includes a negative current collector, and the positive current collector and the negative current collector are made of lead or a lead alloy.

5. The bipolar storage battery according to claim 1, wherein the first adhesive is provided in a peripheral region of a communication hole communicating the one surface and the other surface of the bipolar plate, and a second adhesive is provided in another region other than the peripheral region in the one surface of the bipolar plate.

6. The bipolar storage battery according to claim 5, wherein the positive electrode includes a positive current collector, the negative electrode includes a negative current collector, and the positive current collector and the negative current collector are made of lead or a lead alloy.

7. The bipolar storage battery according to claim 5, wherein the peripheral region where the first adhesive is provided has a shape similar to a shape of the communication hole and is a region surrounding the communication hole about a center of the communication hole.

8. The bipolar storage battery according to claim 7, wherein the positive electrode includes a positive current collector, the negative electrode includes a negative current collector, and the positive current collector and the negative current collector are made of lead or a lead alloy.

9. The bipolar storage battery according to claim 7, wherein when the communication hole has a circular shape, the peripheral region where the first adhesive is provided is between 1.1 times and 1.5 times, inclusive, a diameter of the communication hole.

10. The bipolar storage battery according to claim 9, wherein the positive electrode includes a positive current collector, the negative electrode includes a negative current collector, and the positive current collector and the negative current collector are made of lead or a lead alloy.

11. The bipolar storage battery according to claim 5, wherein when the communication hole has a circular shape, the peripheral region where the first adhesive is provided is between 1.1 times and 1.5 times, inclusive, a diameter of the communication hole.

12. The bipolar storage battery according to claim 11, wherein the positive electrode includes a positive current collector, the negative electrode includes a negative current collector, and the positive current collector and the negative current collector are made of lead or a lead alloy.
